(19) United States
(12) Patent Application Publication
(10) Pub. No.: US 2014/0096801 A1
(43) Pub. Date: Apr. 10, 2014

(54) MAKEUP BRUSH CLEANER AND SANITIZER

(71) Applicants: Matt McCormick, Los Angeles, CA (US); Nidhal McCormick, Los Angeles, CA (US)

(72) Inventors: Matt McCormick, Los Angeles, CA (US); Nidhal McCormick, Los Angeles, CA (US)

(21) Appl. No.: 14/042,630

(22) Filed: Sep. 30, 2013

Related U.S. Application Data
(60) Provisional application No. 61/710,302, filed on Oct. 5, 2012.

(51) Int. Cl. B08B 11/02

(52) U.S. Cl. CPC B08B 11/02
USPC 134/115 R

(57) ABSTRACT

The present invention generally relates to a makeup brush cleaner and sanitizer. Specifically, embodiments of the present invention relate to an apparatus configured to hold multiple cosmetics or other makeup type brushes in specifically designed retention means such that only the brush tips/bristles of the brushes are subject to the sanitation area of the apparatus. Certain embodiments of the present apparatus provide the sanitation area of the apparatus to clean the brush tips/bristles of the retained brushes via one or more of a cleaning solution, water, ultra-violet cleaning source, ultrasonic cleaning source, gentle agitation, or any combination thereof.

### CROSS REFERENCE TO RELATED APPLICATIONS

This application claims the benefit of U.S. Provisional Patent Application No. 61/710,302, filed Oct. 5, 2012, the entire disclosure of which is incorporated herein by reference.

### FIELD OF THE INVENTION

The present invention generally relates to a makeup brush cleaner and sanitizer. Specifically, embodiments of the present invention relate to an apparatus configured to hold multiple cosmetics or other makeup type brushes in specifically designed retention means such that only the brush tips/bristles of the brushes are subject to the sanitation area of the apparatus. Certain embodiments of the present apparatus provide the sanitation area of the apparatus to clean the brush tips/bristles of the retained brushes via one or more of a cleaning solution, water, ultra-violet cleaning source, ultrasonic cleaning source, gentle agitation, or any combination thereof.

### BACKGROUND OF THE INVENTION

Everyday, people commonly use makeup and other cosmetic products to enhance and alter their appearance. One of the most common tools used to apply makeup and other cosmetic products is a brush. These makeup brushes come in a wide variety of shapes and sizes depending on what type of application a brush is intended. After a period of continual use, however, the bristles of a makeup brush can become matted and caked with accumulated makeup residue. At that point in time, it becomes necessary to clean the bristles on the head of the makeup brush to ensure that the brush continues to apply makeup in an effective manner. Cleaning of the brushes may also help prolong the life of the brush. The bristles of a makeup brush, however, are typically delicate and require a gentle cleaning process that does not damage the bristles. The cleaning process can be tedious and time consuming because each makeup brush must be individually cleaned to ensure that brush is not damaged.

Further, brush clips, a metal part of the brush which attaches the bristles to the handle, are generally susceptible to damage by water or other cleaning solutions. Damaged brush clips may cause the attachment between the brush clip and the bristles to become less secure, allowing the bristles to become dislodged or to fall out. Additionally, if water or other cleaning solution is allowed to penetrate the Clip, bacteria can grow in it, creating an unsanitary condition which may jeopardize the health of a user.

Therefore, there is a need in the art for makeup brusher cleaner and sanitizer that can gently and efficiently clean multiple makeup brushes simultaneously. These and other features and advantages of the present invention will be explained and will become obvious to one skilled in the art through the summary of the invention that follows.

### SUMMARY OF THE INVENTION

The present invention provides a device for the cleaning and/or sanitizing makeup brushes. In a preferred embodiment, the device is configured such that the makeup brushes are secured in position that only allows for the brush head of a makeup brush to soak in a cleaning fluid. In alternate embodiments, the device may incorporate alternate or additional cleaning methods that include, but are not limited to, ultra-violet light, ultra-sonic cleaning, and/or gentle agitation.

According to an embodiment of the present invention, an apparatus for a makeup brush sanitizer apparatus, the apparatus comprising: a base portion, comprising a sanitation area and one or more brush retention means, wherein the sanitation area is comprised of one or more brush head cleaning means, wherein the one or more brush head cleansing means are adapted to facilitate the removal of buildup from a brush head portion of a makeup brush, and wherein the one or more brush retention means are configured to securely hold one or more makeup brushes, such that only the brush head portion of each of the one or more makeup brushes is subjected to the sanitation area of said apparatus.

According to an embodiment of the present invention, the makeup brush sanitizer apparatus further includes a lid component.

According to an embodiment of the present invention, a sanitation cycle will not operate unless the lid component is engaged with the base portion.

According to an embodiment of the present invention, the makeup brush sanitizer apparatus further includes a handle component.

According to an embodiment of the present invention, the handle component is incorporated with the lid component.

According to an embodiment of the present invention, the handle component is incorporated with the base portion.

According to an embodiment of the present invention, the one or more brush head cleaning means is selected from a group of brush head cleaning means comprising one or more cleaning fluid basins, ultraviolet light cleaning means, ultrasonic cleaning means, and one or more agitators.

According to an embodiment of the present invention, at least one of the one or more brush head cleaning means is a cleaning fluid basin and the cleaning fluid basin is filled with water.

According to an embodiment of the present invention, at least one of the one or more brush head cleaning means is a cleaning fluid basin and the cleaning fluid basins is filled with a cleaning solution.

According to an embodiment of the present invention, the one or more agitators is selected from a group of agitators comprising pneumatic agitators and physical agitators.

According to an embodiment of the present invention, the one or more brush retention means are selected from a group of brush retention means comprising clips, friction fit rings, reusable adhesive surfaces, magnetic surfaces, and reusable ties.

According to an embodiment of the present invention, the one or more brush retention means is further configured with a height adjustment mechanism.

According to an embodiment of the present invention, the one or more brush retention means are further configured with a protective covering.

According to an embodiment of the present invention, the base portion is further comprised of a sanitation control means, such sanitation control means comprising one or more components selected from the group of a timer, a display element (e.g., LED, LCD), an alert source (e.g., speaker capable of creating an audible tone, LED or other notification indicator) one or more human interface elements allowing for the selection or editing of settings related to a cleaning cycle, including, but not limited to, the length of a cleaning cycle, the type of cleaning cycle (e.g., ultrasonic, agitation, soak), the type of brushes to be cleaned or any combination thereof.

According to an embodiment of the present invention, the sanitation control means is configured to control one or more sanitation cycles.

According to an embodiment of the present invention, the base portion is further comprised of one or more storage compartments.

According to an embodiment of the present invention, the base portion is further comprised of a power source.

According to an embodiment of the present invention, the power source is one or more power sources selected from a group of power sources comprising one or more batteries, one or more rechargeable batteries, AC adapters, DC adapters, and power cords.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a perspective view of a makeup brush cleaner and sanitizer in accordance with an embodiment of the present invention;

FIG. 2 is a perspective view of a makeup brush cleaner and sanitizer with the lid removed in accordance with an embodiment of the present invention;

FIG. 3 is cross-sectional view of the base portion of a makeup brush cleaner and sanitizer in accordance with an embodiment of the present invention;

FIG. 4 is an close-up view of a makeup brush suspended in a cleaning basin in accordance with an embodiment of the present invention; and

FIG. 5 is an close-up view of a retention means of a makeup brush cleaner and sanitizer in accordance with an embodiment of the present invention.

### DETAILED SPECIFICATION

The present invention generally relates to a makeup brush cleaner and sanitizer. Specifically, embodiments of the present invention relate to an apparatus configured to hold multiple cosmetics or other makeup type brushes in specifically designed retention means such that only the brush tips/bristles of the brushes are subject to the sanitation area of the apparatus. Certain embodiments of the present apparatus provide the sanitation area of the apparatus to clean the brush tips/bristles of the retained brushes via one or more of a cleaning solution, water, ultra-violet cleaning source, ultrasonic cleaning source, gentle agitation, or any combination thereof.

According to an embodiment of the present invention, the makeup brush cleaner and sanitizer is comprised of a base portion including a sanitation area and one or more brush retention means for securing makeup brushes. Certain embodiments of the present invention may further be comprised of a sanitation control means, a lid component, one or more storage compartments, a power source, a handle or any combination thereof. One of ordinary skill in the art would appreciate there are multiple configurations that could be utilized with various embodiments of the present invention and embodiments of the present invention are contemplated for use with any combination of the aforementioned components.

According to an embodiment of the present invention, the sanitation area of the base portion is comprised of one or more brush head cleansing means. Brush head cleansing means include, but are not limited to, one or more cleaning fluid basins, ultraviolet light cleaning means, ultrasonic cleaning means, one or more agitators, or any combination thereof. One of ordinary skill in the art would appreciate that there are numerous types of cleansing means that may be utilized with embodiments of the present invention, and embodiments of the present invention are contemplated for use with any type of cleansing means.

In a preferred embodiment of the present invention, the sanitation area may be comprised of a cleaning fluid basin that is configured such that only the brush head portions of the makeup brushes are submerged in a cleaning fluid. In certain embodiments, the basin is further configured with an ultraviolet light source configured to work in conjunction with, or independently of, the cleaning fluids to sanitize the makeup brushes.

In an alternative embodiment, the sanitation area may be comprised of multiple cleaning fluid basins, one basin for each brush. In this configuration, a user can choose which cleaning fluid to use on various brushes, or even allow for certain brushes to be cleansed only by non-liquid means (e.g., ultraviolet light). Additionally, in an alternative embodiment, the brushes may be clipped into the device in an alternative manner, wherein the device may have a central spine which runs vertically from the top of the lid component and has a number of clips which extend out from it to hold the brushes, but so as to accomplish the same goal.

According to an embodiment of the present invention, a cleaning fluid is use in the cleaning fluid basin in order to loosen and remove buildup from the brush head portion of the makeup brush. In certain embodiments, the cleaning fluid is water alone. In other embodiments, the cleaning fluid is a cleaning solution. One of ordinary skill in the art would appreciate that there are a variety of cleaning solutions that would be suitably used as a cleaning fluid in the cleaning fluid basin, and embodiments of the present invention are contemplated for use with any such cleaning solution.

According to an embodiment of the present invention, the brush head cleansing means may be an ultraviolet light cleaning means. In a preferred embodiment, the ultraviolet light cleaning means is an ultraviolet light that sanitizes the brush head portion of a makeup brush. In the preferred embodiment, there may be one or more ultraviolet lights sources within the sanitation area of the base portion of the makeup brush cleaner and sanitizer. By having more than one ultraviolet light source, a user may have greater flexibility in choosing which makeup brushes to expose to the ultraviolet light while keeping other brushes out of the ultraviolet light. Such an arrangement would allow a user to clean multiple different makeup brushes at the same time with different cleaning methods.

According to an embodiment of the present invention, the brush head cleansing means may be an ultrasonic cleaning means. In a preferred embodiment, the ultrasonic cleaning means is an ultrasonic sound source that applies ultrasonic sound waves to a cleaning fluid in the one or more cleaning fluid basins. By applying an ultrasonic frequency to the cleaning fluid, the liquid of the cleaning fluid is gently agitated thereby causing the cleaning fluid to more efficiently remove buildup from the makeup brush.

According to an embodiment of the present invention, the brush head cleansing means may be one or more agitators. In certain embodiments, the agitator may be air jets or similar pneumatically acting agitators. In alternate embodiments, the agitator may be one or more rotating brushes or similar agitator that physically interacts with the bristles of the makeup brush (or physical agitator). One of ordinary skill in the art would appreciate that there are numerous agitators that could effectively clean a makeup brush, and embodiments of the present invention are contemplated for use with any such agitator or any combination thereof.

According to an embodiment of the present invention, the one or more brush retention means of the base portion are configured to be situated and retained above or otherwise near, but not in contact with, the sanitation area of the base portion. The one or more brush retention means are configured to retain one or more makeup brushes in a manner such that only the head or tip of the makeup brushes are inserted into the sanitation area of the makeup brush cleaner and sanitizer apparatus. Advantageously, this allows only the bristles/brush head portion to be subjected to the sanitizing process, thereby preventing damage or other wear on the handle and clip portions of the makeup brushes.

According to an embodiment of the present invention, retention means may include, but are not limited to, clips, friction fit rings, reusable adhesive surfaces, magnetic surfaces, reusable ties, or any combination thereof. One of ordinary skill in the art would appreciate that there are numerous types of retention means that could be utilize with embodiments of the present invention, and embodiments of the present invention are contemplated for use with any type of retention means. In a preferred embodiment of the present invention, the makeup brush cleaner and sanitizer is comprised of a plurality of clips each configured with a protective covering. The protective covering is designed to help retain the handle of a makeup brush in place via a non-abrasive and non-damaging friction fit (e.g., silicon padding on the clips).

In certain embodiments, the one or more brush retention means may be raised and lowered via a height adjustment mechanism. The height adjustment mechanism may allow for the retained brushes to be lowered into and raised out of sanitation area so that only the brush head portions are inserted into the sanitation area. In certain embodiments, the height adjustment mechanism can be further utilized to raise the brush head portions out of the sanitation area after the completion of a sanitation cycle. In this manner, the brush head portions will be allowed to dry quicker, where cleaning fluids are utilized.

According to an embodiment of the present invention, the apparatus may be further comprised of a brush drying means, configured to dry the brushes and/or the bristles of the brushes. In a preferred embodiment, a blow dryer, fan or other air circulating means may be utilized as the brush drying means, such air circulating means being incorporated into the apparatus and controlled by the control means such that the air circulating means is engaged after the completion of a cleaning cycle. In certain embodiments, a moisture sensor can be utilized to detect the amount of moisture remaining and shutoff the air circulating means when the brushes are sufficiently dry. In other embodiments, the air circulating means may be on a timed dry cycle.

According to an embodiment of the present invention, the base portion may further include a sanitation control means. In a preferred embodiment, the sanitation control means is configured with a variety of settings that operate various sanitation cycles of the makeup brush cleaner and sanitizer apparatus. Each of the various sanitation cycles work by selectively engaging one or more of the brush head cleaning means. Setting for the sanitation cycles include, but are not limited to, cleaning type (e.g., selection of one or more sanitizing means—UV only, cleaning fluid only, cleaning fluid+UV, agitation only, agitation+cleaning fluid, agitation+cleaning fluid+UV), sanitation cycle duration, pre-defined start time, pre-defined end time (either in relation to current time or elapsed time), or any combination thereof. One of ordinary skill in the art would appreciate that there are numerous types of settings that could be used with a sanitation control means in accordance with embodiments of the present invention, and embodiments of the present invention are contemplated for use with any type of settings.

According to an embodiment of the present invention, the makeup brush cleaner and sanitizer may be further comprised of a lid component. In certain embodiments, the makeup brush cleaner and sanitizer apparatus may be configured such that a sanitation cycle may not be run without having the lid component affixed to the base portion in order to prevent a user from removing one or more makeup brushes during a sanitation cycle. In certain embodiments, the lid component may be removably attached to the base portion via a lid component connection means. Lid component connection means may include, but are not limited to, friction fits, twist and lock/unlock mechanisms, screw threads, suction means or any combination thereof. One of ordinary skill in the art would appreciate that there are numerous lid component connection means that may be utilized with embodiments of the present invention, and embodiments of the present invention are contemplated for use with any type of lid component connection means.

According to an embodiment of the present invention, the makeup brush cleaner and sanitizer may be further comprised of one or more storage compartments. In certain embodiments, these storage compartments are attached, potentially integrally, to the base portion of the makeup brush cleaner and sanitizer apparatus. The one or more storage compartments are configured to retain parts, solutions or other components for the makeup brush sanitizer. For instance, one or more storage compartments may be configured to retain additional cleaning fluid for the sanitation area(s) or to retain clean and dirty water. Additionally, the makeup brush cleaner and sanitizer could be configured with one or more separate storage compartments for clean makeup brushes and/or dirty make makeup brushes. One of ordinary skill in the art would appreciate that the makeup brush cleaner and sanitizer could be configured with any variety of storage compartments, and embodiments of the present invention are contemplated for use with any such storage compartment.

According to an embodiment of the present invention, the makeup brush cleaner and sanitizer may be further comprised of a power source that supplies power to one or more of the brush head cleansing means. Power sources may include, but are not limited to, one or more batteries, one or more rechargeable batteries, AC adapters, power cords or any combination thereof. One of ordinary skill in the art would appreciate that there are numerous types of power sources that could be utilized with embodiments of the present invention, and embodiments of the present invention are contemplated for use with any type of power source.

According to an embodiment of the present invention, the makeup brush cleaner and sanitizer may be further comprised of a handle to allow for ease of portability. The handle may be attached to one or more components on either the lid component or the base portion and provide stability and support for transportation of the apparatus. In a preferred embodiment of the present invention, the handle would be integrally formed into or on the lid component of the apparatus and allow for easy pickup and carrying of the apparatus. Having the handle on the lid component also allows for improving the ease with which the lid can be removed or attached by providing an area that can be gripped while the lid is being inserted onto or removed from the base portion of the apparatus. One of ordinary skill in the art would appreciate that there are numerous locations and types of handles that could be utilized with embodiments of the present invention, and embodiments of the present invention are contemplated for use with any type and placement of a handle.

### Exemplary Embodiment

Turning now to FIG. 1, a perspective view of a makeup brush cleaner and sanitizer, in accordance with an embodiment of the present invention. In this embodiment, the makeup brush cleaner and sanitizer 100 is comprised of a base portion 102 and a lid 114. In a preferred embodiment, the base portion 100 is configured to clean and/or sanitize the brush head portion 110 of a makeup brush 108.

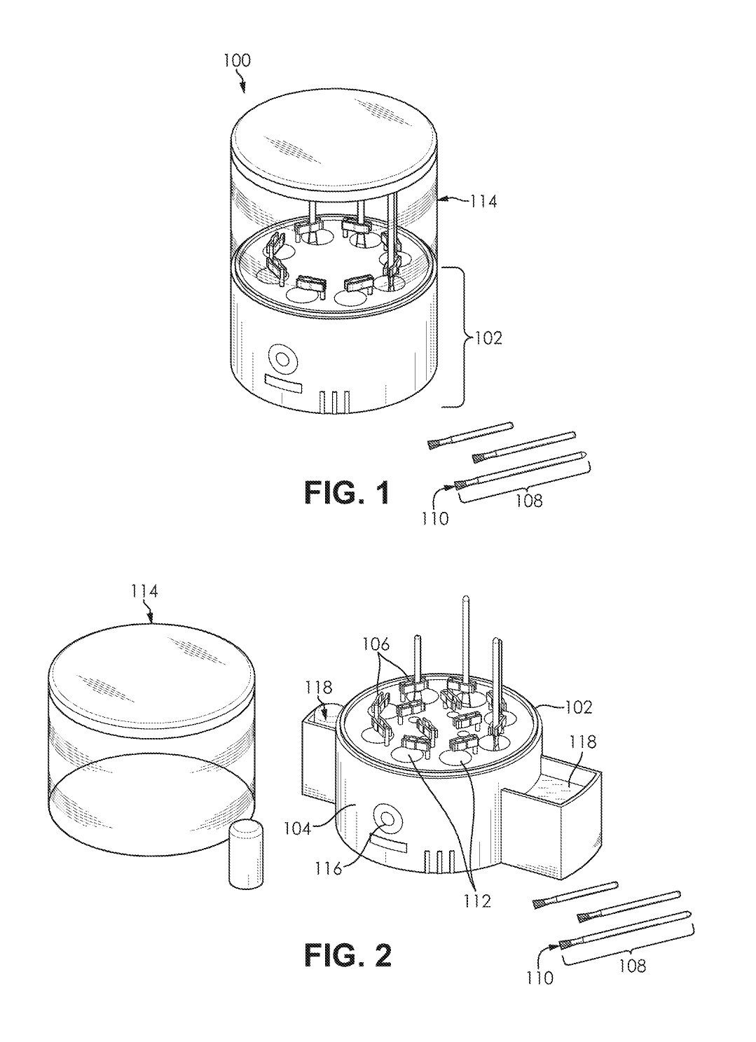

Turning now to FIG. 2, a perspective view of a makeup brush cleaner and sanitizer with the lid removed, in accordance with an embodiment of the present invention. In this embodiment, the lid 114 is removed from the base portion 102 of the makeup brush cleaner and sanitizer. Within the base portion 102 there is a sanitation area 104 and a plurality of retention means 106 that are configured to hold makeup brushes 108. In a preferred embodiment, each retention means 106 is configured to hold a makeup brush 108 within a cleaning fluid basin 112 such that only the brush head portion 110 of the makeup brush 108 is in contact with the cleaning fluid in the cleaning fluid basin 112. The base portion 102 of the makeup brush cleaner and sanitizer may be further configured with a sanitation control means 116 and a plurality of storage compartments 118.

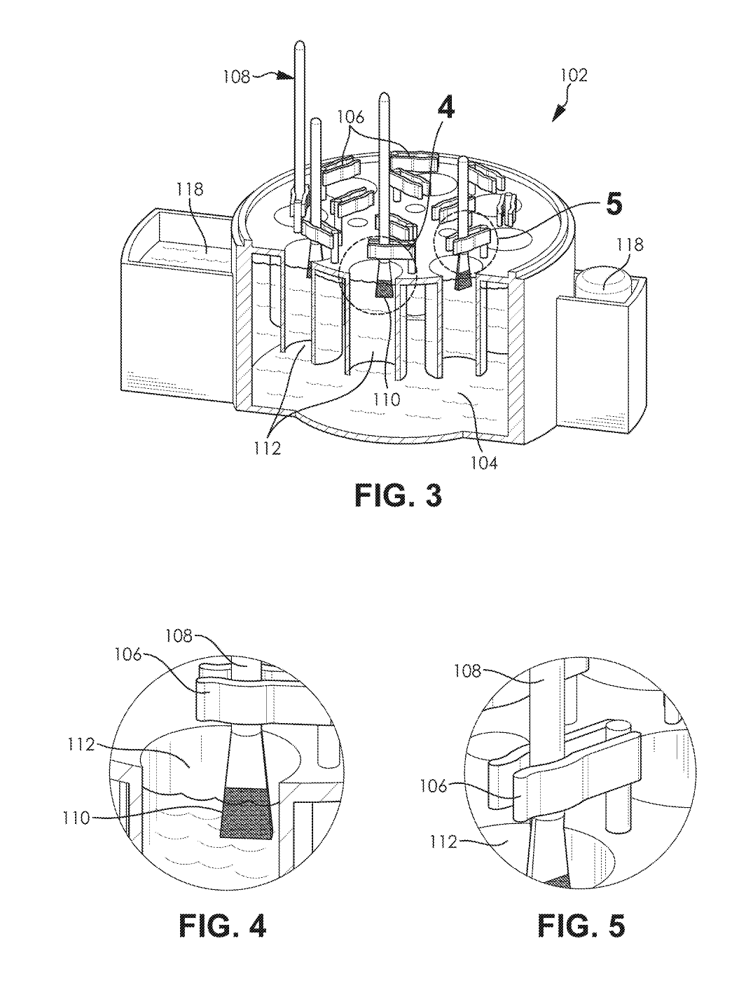

Turning now to FIG. 3, a cross-sectional view of a makeup brush cleaner and sanitizer, in accordance with an embodiment of the present invention. In this embodiment, the sanitation area 104 of the base portion 102 is clearly shown to be filled with a cleaning fluid. In a preferred embodiment, each retention means 106 is configured to hold a makeup brush 108 within a cleaning fluid basin 112 such that only the brush head portion 110 of the makeup brush 108 is in contact with the cleaning fluid in the cleaning fluid basin 112. The base portion 102 of the makeup brush cleaner and sanitizer may be further configured with a plurality of storage compartments 118 for storing excess cleaning fluid or other items.

Turning now to FIG. 4, a close-up view of a makeup brush in cleaning fluid. In this view, the brush head portion 110 of a makeup brush 108 is shown being held by a retention means 106. In a preferred embodiment, the retention means 106 secures the makeup brush 108 such that only the brush head portion 110 of the makeup brush 108 is in contact with the cleaning fluid in the cleaning fluid basin 112.

Turning now to FIG. 5, a close-up view of a makeup brush secured by a retention means. In a this view, the makeup brush 108 is being securely held by the retention means 106 such that the makeup brush is securely held within the cleaning fluid basin 112. In a preferred embodiment, the retention means 106 is a clip that firmly holds the make-up brush 108 without causing any damage to the handle of the makeup brush.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A makeup brush sanitizer apparatus, said apparatus comprising:
a base portion, comprising a sanitation area and one or more brush retention means,
wherein said sanitation area is comprised of one or more brush head cleaning means,
wherein said one or more brush head cleansing means are adapted to facilitate the removal of buildup from a brush head portion of a makeup brush, and
wherein said one or more brush retention means are configured to securely hold one or more makeup brushes, such that only said brush head portion of each of said one or more makeup brushes is subjected to said sanitation area of said apparatus.

2. The apparatus of claim 1, further comprising a lid component.

3. The apparatus of claim 2, wherein a sanitation cycle will not operate unless said lid component is engaged with said base portion.

4. The apparatus of claim 1, further comprising a handle component.

5. The apparatus of claim 4, wherein said handle component is incorporated with said lid component.

6. The apparatus of claim 4, wherein said handle component is incorporated with said base portion.

7. The apparatus of claim 1, wherein said one or more brush head cleaning means is selected from a group of brush head cleaning means comprising one or more cleaning fluid basins, ultraviolet light cleaning means, ultrasonic cleaning means, and one or more agitators.

8. The apparatus of claim 1, wherein at least one of said one or more brush head cleaning means is a cleaning fluid basin and said cleaning fluid basin is filled with water.

9. The apparatus of claim 1, wherein at least one of said one or more brush head cleaning means is a cleaning fluid basin and said cleaning fluid basins is filled with a cleaning solution.

10. The apparatus of claim 7, wherein in said one or more agitators is selected from a group of agitators comprising pneumatic agitators and physical agitators.

11. The apparatus of claim 1, wherein said one or more brush retention means are selected from a group of brush retention means comprising clips, friction fit rings, reusable adhesive surfaces, magnetic surfaces, and reusable ties.

12. The apparatus of claim 1, wherein in said one or more brush retention means is further configured with a height adjustment mechanism.

13. The apparatus of claim 1, wherein said one or more brush retention means are further configured with a protective covering.

14. The apparatus of claim 1, wherein said base portion is further comprised of a sanitation control means.

15. The apparatus of claim 14, wherein said sanitation control means is configured to control one or more sanitation cycles.

16. The apparatus of claim 1, wherein said base portion is further comprised of one or more storage compartments.

17. The apparatus of claim 1, wherein said base portion is further comprised of a power source.

18. The apparatus of claim 17, wherein said power source is one or more power sources selected from a group of power sources comprising one or more batteries, one or more rechargeable batteries, AC adapters, DC adapters, and power cords.
